(19) United States
(12) Patent Application Publication
(10) Pub. No.: US 2002/0054805 A1
(43) Pub. Date: May 9, 2002

(54) Fastening element

(76) Inventors: Werner Kaibach, Buchloe (DE); Stefan Raber, Kaufering (DE); Andreas Eckstein, Landsberg am Lech (DE)

Correspondence Address: David Toren, BROWN & WOOD LLP, 875 Third Avenue, New York, NY, 10022, US

(21) Appl. No.: 10/001,763

(22) Filed: Oct. 31, 2001

(30) Foreign Application Priority Data
Nov. 3, 2000 (DE) 100 54 618.8

(51) Int. Cl. F16B 13/06

(52) U.S. Cl. 411/60.1

(57) ABSTRACT

A fastening element including a stem (1) provided at one of its opposite end with a load application element (2) and at another of its end with a cone for expanding an expansion sleeve (4) at least partially surrounding the stem and having at least one longitudinal slot (6) that forming expansion segments (5) provided each with two locking elements (15) radially projecting beyond an outer contour of the expansion sleeve (4), arranged one behind another in the setting direction at a distance from each other, and having, in a plane extending through a longitudinal axis of the stem (1), a substantially uniform cross-section.

### BACKGROUND OF THE INVENTION

1. Field of the Invention

The present invention relates to a fastening element for being anchored in a bore of a constructional component and having a stem provided at its end facing in a direction opposite a setting direction of the fastening element with a load application element, an expansion sleeve at least partially surrounding the stem and having at least one longitudinal slot open at its setting direction end and forming expansion segments provided each with locking elements radially projecting beyond an outer contour of the expansion sleeve, and an expansion cone provided at a setting direction end of the stem for expanding the expansion sleeve.

2. Description of the Prior Art

Fastening elements of the type described above are particularly suitable for anchoring in hard constructional components when by screwing a nut over a threaded portion of the fastening element stem, which projects above the connectable object, the expanding cone is pulled into the expansion sleeve which is supported against a wall of the bore the fastening element is set in. Upon pulling of the expanding cone into the expansion sleeve, the sleeve expands and wedges in the bore. The locking elements, which are hooked in the bore wall, provide for support of the expansion sleeve in the bore. The longitudinal slot, which is formed in the expansion sleeve, forms expansion segments which form, at the closed end of the slot, a closed contour.

German Publication DE-A1-43 44 244 discloses a fastening element of the type described above with a stem at the end of which there is provided a cone for expanding the expansion elements. The expansion elements have each a plurality of arranged in the setting direction one after another, locking elements formed by stamping. The locking elements have a triangular shape with the tip of the triangle facing in the setting direction.

A drawback of the fastening element disclosed in DE-A-1 43 44 244 consists in that this fastening element is optimized for use in a cracked concrete and therefore, does not insure obtaining of desired load values in a non-cracked concrete.

Accordingly, an object of the present invention is to provide a fastening element of the type disclosed above and which would provide for obtaining of optimal load values upon its anchoring in both the cracked concrete and the non-cracked concrete.

Another object of the present invention is to provide a fastening element of the type described above which can be economically produced.

### SUMMARY OF THE INVENTION

These and other objects of the present invention, which will become apparent hereinafter, are achieved by providing two locking elements arranged one behind another in the setting direction at a distance from each other, and having, in a plane extending through a longitudinal axis of the stem, a substantially uniform cross-section.

The provision of two, arranged in the setting direction one after another and spaced from each other, locking elements having a uniform cross-section in a plane extending through the longitudinal axis of the stem, permitted to obtain optimal load values as in a cracked construction component so in a non-cracked constructional component and, in particular, in both cracked and non-cracked concrete. The front locking element engages the bore wall first. It serves for insuring a reliable anchoring, in particular, in a high-strength concrete, in connection with, e.g., a used drill. In this particular case the bore is relatively small. In this case, a torque, which is used in the setting process should be high enough to insure that the front locking element is completely pressed into a constructional component, in particular, concrete. Preferably, the front locking element extends over the entire circumference of the expansion segment.

The rear locking element serves for insuring a reliable anchoring of the fastening element in a low-strength concrete, in particular, when the bore is relatively large. The rear locking element can extend only over a portion of the circumference of an expansion segment. When the fastening element is anchored in a cracked concrete, both the front and rear locking elements together prevent the fastening element from being extracted. To insure an optimal engagement of the locking elements in a constructional component, preferably, the height, by which the locking elements radially project beyond the outer contour of the expansion sleeve corresponds to 0.02-0.01 times and, in particular, to 0.03-0.05 times of the core diameter of the expansion sleeve.

In order to obtain optimal load ratios in both cracked and non-cracked concrete, preferably, the distance between the locking elements is so selected that it corresponds to 0.2-1.5 times and, in particular to 0.5-0.7 times of the core diameter of the expansion sleeve.

The distance between the locking elements plays an important role in insuring of a most possible uniform introduction of forces into a constructional component. At that, it should be ascertained that the constructional component is not weakened or distorted in the region of the locking elements. If the locking elements are spaced too far from each other, a pointed introduction of forces takes place. On the other hand, if the locking elements are arranged too close to each other, they weaken the constructional component in the region of the locking elements or completely destroy the constructional component in this region.

To obtain an optimal engagement of the locking elements in a constructional component, advantageously, they are provided with a triangular cross-section in a plane extending transverse to the longitudinal axis of the stem. When selecting the geometry of a locking element, care should be taken to avoid any weakening of a region of the constructional component remote from the locking element in the setting direction. This is particularly insured when the locking elements have a cross-section of an isosceles triangle in the plane extending through to the longitudinal axis of the stem.

In accordance with another advantageous embodiment of the present invention, the locking elements have a rectangular cross-section in the plane extending through to the longitudinal axis of the stem. This cross-section of the locking elements proved to be advantageous when fastening elements are anchored in a weak constructional component.

Advantageously, the expanding cone has a cylindrical section having a length corresponding to 0.3-1.5 times, in particular to 0.6-0.9 times of the distance between the locking elements. The provision of such a cylindrical section insures an optimal force transmission between the expanding cone and the expansion sleeve. With the locking elements having unequal heights, the cylindrical section can have a slightly rounded geometry to optimize the introduction of forces to a constructional component.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS:

The drawings show:

FIG. 1 A cross-sectional view of a fastening element according to the present invention; and

FIG. 2 a cross-sectional view, at an increased, in comparison with FIG. 1, scale, of an expansion member of the fastening element shown in FIG. 1.

### DETAILED DESCRIPTION OF THE PREFERRED EMBODIMENT

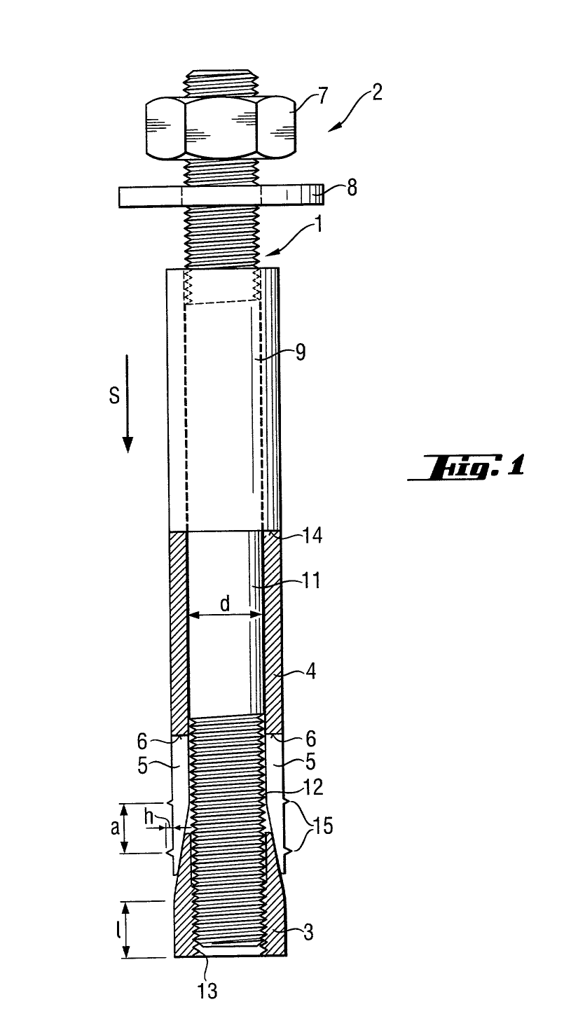

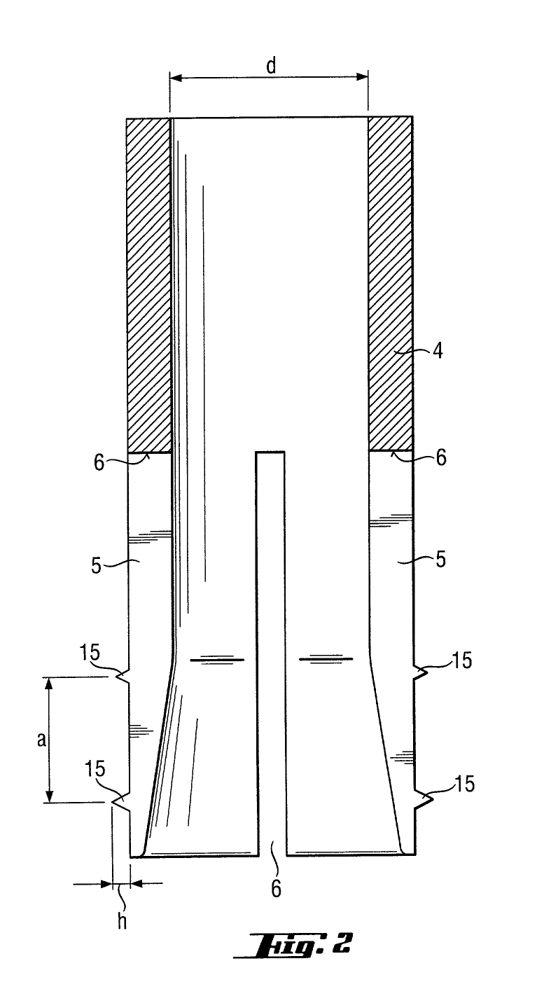

A fastening element according to the present invention, which is shown in FIGS. 1-2, has a stem 1 provided at its end, which faces in a direction opposite to the setting direction S, with load application means 2 and at its end, which faces in the setting direction S, with an expanding cone 3 for expanding an expansion sleeve 4. The sleeve 4 surrounds the stem 1 and has at least one slot 6 that forms expansion segments 5.

The stem 1 is formed as a threaded stem on which a nut 7 is screwed on, with the use of a washer 8, as shown in FIG. 1. The stem 1 has a transverse load region 9 adjoining the load application means 2. On the stem 1, between the transverse load region 9 and the expanding cone 3, there is provided a receiving region 11 along which the expansion sleeve is guided. The receiving region 11 has a smaller diameter than the transverse load region 9. At its setting direction end, the receiving region has an outer thread 12 which serves as connection means. The expanding cone 3, which is provided with an inner thread 13 complementary to the thread 12, is screwed on the setting direction side end of the receiving region 11. The stem 1 and the transverse load region 9 can be formed as a one-piece element.

The expansion sleeve 4 has generally substantially the same outer diameter as the transverse load region 9. At its end facing in the direction opposite the setting direction, the expansion sleeve 4 cooperates with a stop shoulder 14 of the transverse load region 9. The longitudinal slot 6 is open at its setting direction end, a particularly shown in FIG. 1.

The expansion segments 5 are provided with locking elements 15 which project beyond the outer contour of the expansion sleeve 4 radially by a height h. Each segment 5 has two, axially spaced by a distance a, locking elements 15 arranged one behind the other. The radial height h of a locking element 15 corresponds to 0.03-0.05 of a core diameter d of the expansion sleeve 4. The distance a between the following one another, locking elements 15 corresponds to 0.5-0.7 of the core diameter d of the expansion sleeve 4. The locking elements 15 have a triangular cross-section in a plane extending through the longitudinal axis of the stem 1. A locking element 15, adjacent to an end of the sleeve 4 facing in the setting direction, has a height h greater than the height of a locking element 15 remote from the facing in the setting direction, end of the sleeve 4. The expanding cone 3 is provided at its setting direction end with a cylindrical section having a length 1 that corresponds to 0.6-0.9 of the axial distance a between two locking elements. The cylindrical section is slightly rounded in its transitional region to the cone section to insure a uniform force distribution in a constructional component (not shown) when the locking elements 15 engage thereinto.

Though the present invention was shown and described with references to the preferred embodiment, such are merely illustrative of the present invention and are not to be construed as a limitation thereof, and various modifications to the present invention will be apparent to those skilled in the art. It is, therefore, not intended that the present invention be limited to the disclosed embodiment or details thereof, and the present invention includes all of variations and/or alternative embodiments with the spirit and scope of the present invention as defined by the appended claims.

What is claimed is:

1. A fastening element for being anchored in a bore of a constructional component, comprising a stem (1) provided at an end thereof facing in a direction opposite a setting direction of the fastening element with load application means (2); an expansion sleeve (4) at least partially surrounding the stem and having at least one longitudinal slot (6) open at a setting direction end thereof and forming expansion segments (5) provided with two locking elements (15) radially projecting beyond an outer contour of the expansion sleeve (4) by a height (h), arranged one behind another in the setting direction at a distance (a) from each other, and having, in a plane extending through a longitudinal axis of the stem (1), a substantially uniform cross-section; and an expansion cone (3) provided at a setting direction end of the stem (1) for expanding the expansion sleeve.

2. A fastening element according to claim 1, wherein the height (h), by which the locking elements (15) project beyond the outer contour of the expansion sleeve (4) corresponds to 0.02-0.1 times of a core diameter (d) of the expansion sleeve (4).

3. A fastening element according to claim 2, wherein the locking elements (15) of each segment (5) project beyond the outer contour of the expansion sleeve (4) by different heights (h).

4. A fastening element according to claim 1, wherein the distance (a) between the locking elements corresponds to 0.2-1.5 times of a core diameter (d) of the expansion sleeve (4).

5. A fastening element according to claim 4, wherein the distance (a) between the locking elements (15) corresponds to 0.5-0.7 times of the core diameter (d) of the expansion sleeve (4).

6. A fastening element according to claim 1, wherein the locking elements (15) have, in the plane extending through the stem longitudinal axis, a triangular cross-section.

7. A fastening element according to claim 1, wherein the locking elements (15) have, in the plane extending through the stem longitudinal axis, a rectangular cross-section.

8. A fastening element according to claim 1, wherein the expansion cone (3) has a cylindrical section having a length (1) corresponding to 0.3-1.5 times of the distance (a) between the locking elements.
